(19) United States
(12) Patent Application Publication
(10) Pub. No.: US 2022/0011533 A1
(43) Pub. Date: Jan. 13, 2022

(54) ZOOM LENS GROUP

(71) Applicant: AAC Optics Solutions Pte. Ltd., Singapore city (SG)

(72) Inventors: Jarno Matikainen, Tampere (FI); Tomi Lintulahti, Tampere (FI)

(21) Appl. No.: 17/005,357

(22) Filed: Aug. 28, 2020

(30) Foreign Application Priority Data
Jul. 9, 2020 (CN) 202010659609.5

(51) Int. Cl. G02B 7/02; G02B 15/14

(52) U.S. Cl. CPC G02B 7/023; G02B 15/142

(57) ABSTRACT

A zoom lens group is provided and includes a cover, a first magnetic device and at least two lenses. The cover includes an installation cavity, and the first magnetic device is connected to the cover. Each of the at least two lenses is movably arranged in the installation cavity and provided with a second magnetic device. The first magnetic device is configured to attract the second magnetic device to calibrate each of the at least two lenses, in such a manner that axes of the at least two lenses coincide with each other. The zoom lens group can calibrate the camera lenses, thereby increasing precision of the zoom lens group and improving the imaging effect.

### TECHNICAL FIELD

The present disclosure relates to the technical field of optical products, and in particular, to a zoom lens group.

### BACKGROUND

A zoom lens group is a set of camera lenses, each of which can change its focal distance within a certain range to obtain view angles with different widths. The zoom lens group can change the imaging range by changing the focal distance without changing an imaging distance. One zoom lens group can be used as a number of fixed-focus camera lenses, thereby decreasing the number of photographic equipment that would be carried when traveling, and saving time for changing the camera lenses.

Multiple camera lenses are provided in the zoom lens group, and the focal distance of the zoom lens group can be adjusted by adjusting a distance between camera lenses. The zoom lens group in the related art cannot calibrate each camera lens when adjusting the position of each camera lens, and there is a certain radial offset between camera lenses. The zoom lens group is a precise device, even if the offset thereof is very small, it will still seriously affect an imaging effect, thereby causing a poor user experience.

### SUMMARY

The present disclosure provides a zoom lens group, which can calibrate the camera lenses, thereby increasing precision of the zoom lens group and improving the imaging effect.

The above and other purposes will be achieved by the features recited in the independent claims. Some implementations are illustrated in the dependent claims, the description and the drawings.

An embodiment of the present disclosure provides a zoom lens group, the zoom lens group includes a cover including an installation cavity, a first magnetic device connected to the cover, and at least two camera lenses. Each of the at least two camera lenses is movably arranged in the installation cavity and is provided with a second magnetic device. The first magnetic device is configured to attract the second magnetic device to calibrate each of the at least two camera lenses, in such a manner that axes of the at least two camera lenses coincide with each other.

In the scheme described above, the cover and the camera lens are respectively provided with the first magnetic device and the second magnetic device, and the first magnetic device attracts the second magnetic device to calibrate a position of each camera lens, in such a manner that the axes of the respective camera lenses coincide with other. In this way, a precision of the zoom lens group is improved, and the imaging effect. is improved, thereby providing better user experience.

In an embodiment, the first magnetic device is arranged along a direction in which the installation cavity extends.

In the scheme described above, the first magnetic device can be a bar-shaped part, which is arranged along the direction in which the installation cavity extends. The first magnetic device is located at a side of the installation cavity. When the camera lens is installed in the installation cavity, the first magnetic device attracts each camera lens, and each camera lens is subjected to a magnetic attractive force in a same direction, and is uniformly moved and positioned in a same direction, in such a manner that the axes of the camera lenses can coincide with each other. Therefore, a precision of the zoom lens group is significantly improved.

In an embodiment, the cover is provided with an installation groove, and the first magnetic device is at least partially embedded in the installation groove.

In the scheme described above, the installation groove provided in the installation cavity can facilitate the installation of the first magnetic device, thereby improving an installation efficiency. Moreover, embedding the first magnetic device in the installation groove can improve installation stability of the first magnetic device. Embedding the first magnetic device into the installation groove can also decrease a space occupied by the first magnetic device in the installation cavity, thereby preventing the first magnetic device from contacting the camera lens.

In an embodiment, the cover includes a first cover wall and a second cover wall, a transition portion is provided between the first cover wall and the second cover wall, and the first magnetic device is provided at the transition portion.

In the scheme described above, when the camera lens is installed into the cover, an outer wall of the camera lens is supported by the first cover wall and the second cover wall. The camera lens can have a cylindrical shape, so a gap is formed between the camera lens and the transition portion arranged between the first cover wall and the second cover wall, which make it more suitable for installing the first magnetic device at the transition portion. The installation groove can be provided at the transition portion.

In an embodiment, the first cover wall is perpendicularly connected to the second cover wall, and each of a normal of the first magnetic device and a normal of the second magnetic device forms an angle of 45° with the first cover wall.

In the scheme described above, each of the normal of the first magnetic device and the normal of the second magnetic device forms the angle of 45° with the first cover wall, thus the second magnetic device is subjected to a magnetic attractive force at the angle of 45°, thereby calibrating each camera lens in two directions of the first cover wall and the second cover wall. In this way, the precision of the zoom lens group can be improved.

In an embodiment, each of the at least two camera lenses includes a lens barrel and a lens connected to the lens barrel, and the lens barrel includes a main body and a second magnetic device connected to the main body.

In the scheme described above, the second magnetic device can be only a small piece of structure, which is arranged at a surface of the main body. The first magnetic device attracts the second magnetic device of each camera lens, in such a manner that each camera lens automatically rectifies a deviation.

In an embodiment, the main body includes an installation base, and the second magnetic device is connected to the installation base.

In the scheme described above, the installation base protrudes from the main body, and the second magnetic device is installed to the installation base, such that the second magnetic device is close to the first magnetic device. In this way, the magnetic attractive force between the second magnetic device and the first magnetic device is enhanced, thereby improving the calibration precision.

In an embodiment, the installation base includes a groove, and the second magnetic device is embedded in the groove.

In the scheme described above, the groove provided in the installation base can facilitate installation of the second magnetic device, thereby improving an installation efficiency. Moreover, embedding the second magnetic device into the groove can improve installation stability of the second magnetic device, which prevents the second magnetic device from falling off.

In an embodiment, a gap is formed between the first magnetic device and the second magnetic device.

In the scheme described above, the first magnetic device does not contact the second magnetic device, and the gap is formed therebetween. Therefore, there is no friction between the first magnetic device and the second magnetic device, thereby decreasing the sliding resistance of the camera lens.

In an embodiment, the first magnetic device is an iron bar, and the second magnetic device is a magnet.

The technical solution provided by the embodiments of the present disclosure can achieve the following beneficial effects.

In the present disclosure, the cover and the camera lens are respectively provided with the first magnetic device and the second magnetic device, and the first magnetic device attracts the second magnetic device to calibrate a position of each camera lens, such that the axes of the camera lenses coincide with other. In this way, the precision of the zoom lens group and the imaging effect are improved, thereby providing better user experience.

The embodiments of the present disclosure will be described in details in the following with reference to the accompanying drawings.

### BRIEF DESCRIPTION OF DRAWINGS

The accompanying drawings is a part of the present disclosure to provide further understanding of the present disclosure. The schematic embodiments and descriptions of the present disclosure are intended to explain the present disclosure rather than limit the present disclosure. Obviously, the accompanying drawings in the following description are merely some embodiments, and those skilled in the art can obtain other drawings based on these drawings without creative efforts.

FIG. 1 is a perspective schematic diagram of a zoom lens group according to an embodiment of the present disclosure;

FIG. 2 is a schematic diagram illustrating cooperation between a camera lens shown in FIG. 1 and a first magnetic device;

FIG. 3 is a front view of a camera lenses of a zoom lens group according to an embodiment of the present disclosure;

FIG. 4 is a front view of a cover of a zoom lens group according to an embodiment of the present disclosure;

FIG. 5 is a front view of a zoom lens group according to an embodiment of the present disclosure; and

FIG. 6 is an enlarged view of a part A shown in FIG. 5.

### REFERENCE NUMERALS

100—zoom lens group;
   1—cover;
      11—first cover wall;
      12—second cover wall;
      13—transition portion;
         131—installation groove;
      14—installation cavity;
         141—arc-shaped inner wall surface;
         142—position-limiting portion
   2—camera lens;
      21—lens barrel;
         211—main body;
         2111—second magnetic device;
         2112—installation base;
         2113—arc-shaped surface;
         2114—planar surface;
      22—lens;
   3—first magnetic device
   k—normal of the first magnetic device/normal of the second magnetic device;
   a—angle formed between the normal k and the first cover wall.

The drawings herein are incorporated into and constitute a part of the present specification, illustrate embodiments of the present disclosure and explain principles of the present disclosure together with the specification.

It should be noted that these accompanying drawings and wording descriptions are not intended to limit the scope of the present disclosure in any way, but to explain the concept of the present disclosure to those skilled in the art by referring to embodiments.

### DESCRIPTION OF EMBODIMENTS

The terms used in the embodiments of the present disclosure are merely for the purpose of describing particular embodiments but not intended to limit the present disclosure. Unless otherwise noted in the context, the expressions “a”, “an”, “the” and “said” in singular forms used in the embodiments and appended claims of the present disclosure are also intended to represent objects in plural forms.

It should be understood that the term “and/or” used herein is merely an association relationship describing associated objects, indicating that there may be three relationships, for example, A and/or B may indicate that three cases, i.e., A alone, A and B, B alone. In addition, the character “/” herein generally indicates that the related objects before and after the character form an “or” relationship.

It should be understood that in the description of the present disclosure, the terms such as “above”, “under” and the like are used to indicate positions shown in the drawing, instead of being construed as limitations of the embodiment of the present disclosure. In addition, when an element is described as being connected to another element in the context, it should be understood that the element can be directly or via an intermediate element connected to another element.

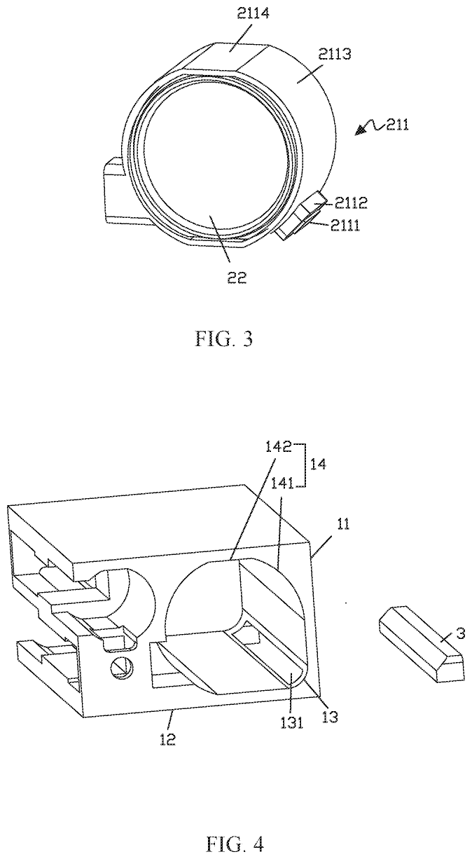

As shown in FIG. 1 and FIG. 4, an embodiment of the present disclosure provides a zoom lens group 100 including a cover 1 and at least two camera lenses 2. The cover 1 includes an installation cavity 14, and each camera lens 2 is movably arranged in the installation cavity 14. A focal distance of the zoom lens group 100 can be adjusted by adjusting a distance between the camera lenses 2, so as to adjust view angles with different widths.

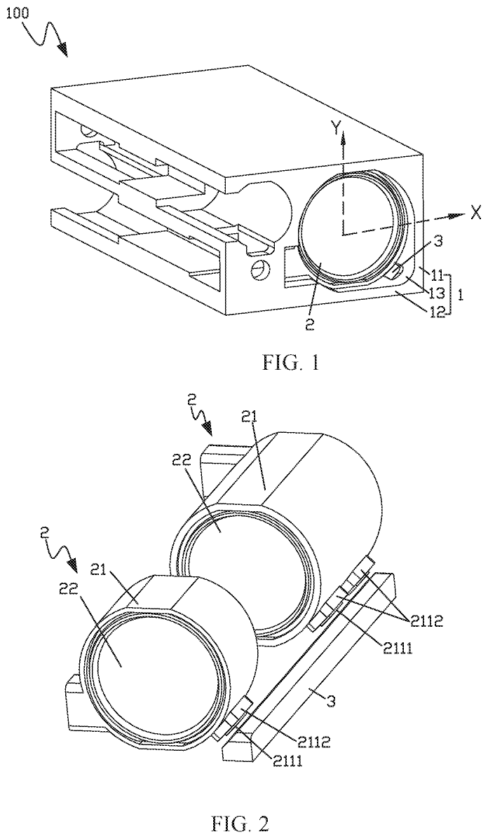

As shown in FIG. 1, FIG. 2 and FIG. 4, the zoom lens group 100 provided by the embodiment of the present disclosure includes the cover 1, a first magnetic device 3 and at least two camera lenses 2. The cover 1 includes the installation cavity 14, and the first magnetic device 3 is connected to the cover 1. Each camera lens 2 is movably arranged in the installation cavity 14, and each camera lens 2 is provided with a second magnetic device 2111. The first magnetic device 3 is configured to attract the second magnetic device 2111 to calibrate each camera lens 2, thereby making axes of the respective camera lenses 2 coincide with each other.

In this implementation manner, the cover 1 and the camera lens 2 are respectively provided with the first magnetic device 3 and the second magnetic device 2111, and the first magnetic device 3 attracts the second magnetic device 2111 to calibrate a position of each camera lens 2, such that the axes of the respective camera lenses 2 coincide with other. In this way, the imaging effect is improved, thereby providing better user experience.

As shown in FIG. 1, FIG. 2 and FIG. 4, in an embodiment, the first magnetic device 3 is arranged along a direction along which the installation cavity 14 extends.

In the solution described above, the first magnetic device 3 can be a bar-shaped part, which is arranged along the direction along which the installation cavity 14 extends. The first magnetic device 3 is located at a side of the installation cavity 14. When the camera lens 2 is installed in the installation cavity 14, the first magnetic device 3 attracts each camera lens 2, and camera lenses 2 are subjected to a magnetic attractive force in a same direction, and are moved and positioned in a same direction due to a same direction in which theses camera lenses 2 are subjected to the force. After a position of the camera lens 2 is adjusted, the camera lens 2 has a very small offset. However, the zoom lens group is a precise device, even if the offset thereof is very small, it will still seriously affect an imaging effect. In this embodiment, camera lenses 2 are moved and positioned in a same direction under the magnetic attractive force supplied by the first magnetic device 3, such that the axes of the respective camera lenses 2 can coincide with each other. Therefore, a precision of the zoom camera lens 2 is significantly improved.

As shown in FIG. 1 and FIG. 4, in an embodiment, the cover includes an installation groove 131, and the first magnetic device 3 is at least partially embedded in the installation groove 131.

In this embodiment, the installation groove 131 provided in the installation cavity 14 can facilitate installation of the first magnetic device 3, thereby improving an installation efficiency. Moreover, embedding the first magnetic device 3 in the installation groove 131 can improve installation stability of the first magnetic device 3. Embedding the first magnetic device 3 in the installation groove can also decrease a space occupied by the first magnetic device 3 in the installation cavity 14, thereby preventing the first magnetic device 3 from contacting the camera lens 2 to affect the calibration precision.

As shown in FIG. 4, in an embodiment, the cover 1 includes a first cover wall 11 and a second cover wall 12, and a transition portion 13 is provided between the first cover wall 11 and the second cover wall 12. The first magnetic device 3 is connected to the transition portion 13.

In this embodiment, when the camera lens 2 is installed in the cover 1, an outer wall of the camera lens 2 is supported by the first cover wall 11 and the second cover wall 12. The camera lens 2 can have a cylindrical shape, such that a gap is formed between the camera lens 2 and the transition portion 13 arranged between the first cover wall 11 and the second cover wall 12. The installation groove 131 is provided on the transition portion 13, in such a manner that the first magnetic device 3 is installed at the transition portion 133.

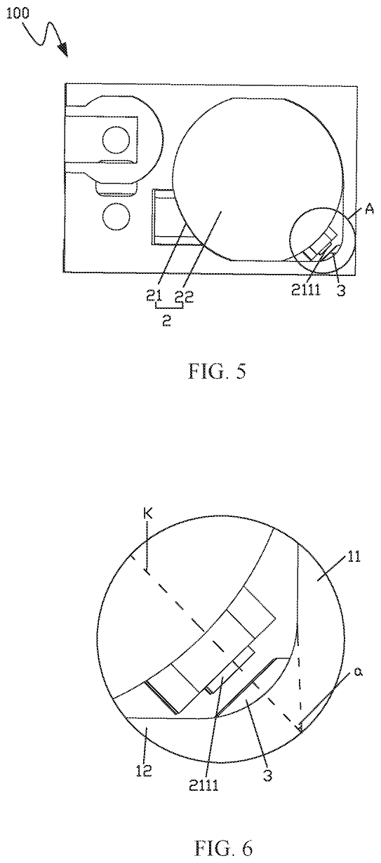

As shown in FIG. 4, FIG. 5 and FIG. 6, in an embodiment, the first cover wall 11 is perpendicularly connected to the second cover wall 12, and each of a normal k of the first magnetic device 3 and a normal k of the second magnetic device 2111 forms an angle “a”. The angle “a” can be 45°.

In the embodiment, each of the normal k of the first magnetic device 3 and a normal of the second magnetic device 2111 forms an angle of 45°, such that the second magnetic device 2111 is subjected to a magnetic attractive force at the 45° angle, thereby calibrating each camera lens 2. In this way, the axes of the respective camera lenses 2 can coincide with each other, thereby improving the precision of the zoom lens group 100.

Two lenses 2 have same zero contact surfaces at cover in two directions, such as X direction and Y direction, that is, the cover 1 creates a guide structure from a same surface for the two lenses 2. The same zero contact surfaces at cover in two directions for both lenses means that the cover creates guiding element from same surfaces for both lenses. Magnets pulls both lenses against cover guiding surfaces. An X-guiding surface and a Y-guiding surface are made in same process step for both lenses, which minimizes the location variation between the lenses. In an embodiment, the first magnetic device 3 attracts the two lenses 2 to a guide surface of the cover 1. For the two lenses 2, guide surfaces of the first cover wall 11 and the second cover wall 12 of the cover 1 are manufactured in a same process step, which minimizes location variation between the lenses 2.

As shown in FIG. 2 and FIG. 3, in an embodiment, the camera lens 2 includes a lens barrel 21 and a lens 22 connected to the lens barrel 21. The lens barrel 21 includes a main body 211 and a second magnetic device 2111 connected to the main body 211.

In the embodiment, the second magnetic device 2111 can be only a small piece of structure, which is arranged on a certain position of a surface of the main body 211. The first magnetic device 3 attracts the second magnetic device 2111 of each camera lens 2. Under the attraction of the first magnetic device 3, a contact surface between each camera lens 2 and the first cover wall 11 and a contact surface between the camera lens 2 and the second cover wall 12 have a same area, thereby improving the precision of the zoom lens group.

As shown in FIG. 2 and FIG. 3, in an embodiment, the main body 211 includes an installation base 2112, and the second magnetic device 2111 is connected to the installation base 2112.

In the embodiment, the installation base 2112 protrudes from the main body 211, and the second magnetic device 2111 is installed on the installation base 2112, such that the second magnetic device 2111 is close to the first magnetic device 3. In this way, the magnetic attractive force between the second magnetic device 2111 and the first magnetic device 3 is enhanced, thereby improving the calibration precision.

In an embodiment, the installation base 2112 includes a groove, and the second magnetic device 2111 is embedded in the groove.

In the embodiment, the groove provided in the installation base 2112 can facilitate installation of the second magnetic device 2111, thereby improving an installation efficiency. Moreover, embedding the second magnetic device 2111 in the groove can improve installation stability of the second magnetic device 2111, which can prevent the second magnetic device 2111 from falling off.

As shown in FIG. 5 and FIG. 6, in an embodiment, a gap is formed between the first magnetic device 3 and the second magnetic device 2111.

In the embodiment, the first magnetic device 3 does not contact the second magnetic device 2111, and a gap is formed between the first magnetic device 3 and the second magnetic device 2111. Therefore, there is no friction between the first magnetic device 3 and the second magnetic device 2111 when the camera lens 2 slides, thereby decreasing the sliding resistance of the camera lens 2.

As shown in FIG. 2, in an embodiment, the first magnetic device 3 is an iron bar, and second magnetic device 2111 is a magnet.

It should be noted that each camera lens 2 is provided with at least one second magnetic device 2111. When the camera lens 2 has a large length, a same camera lens 2 can be provided with multiple second magnetic devices 2111, and the multiple second magnetic devices 2111 are space apart from each other and located at a same side of the camera lens 2. A connection line connecting the multiple second magnetic devices 2111 is perpendicular to the lens 22 of the camera lens 2 and parallel with the first magnetic device 3.

As shown in FIG. 3 to FIG. 5, in an embodiment, the installation cavity 14 includes a position-limiting portion 142. When the camera lens 2 is installed in the installation cavity 14, the position-limiting portion 142 is configured to limit the camera lens 2 such that the second magnetic device 2111 is directly opposite to the first magnetic device 3.

In an embodiment, the installation cavity 14 includes an arc-shaped inner wall surface 141. The position-limiting portion 142 includes a straight inner wall surface connected to the arc-shaped inner wall surface 141. The main body 211 includes an arc-shaped surface 2113 and a planar surface 2114. The arc-shaped surface 2113 and the arc-shaped inner wall surface 141 coordinate with each other, and the planar surface 2114 and the straight inner wall surface coordinate with each other.

In the embodiment, the position-limiting portion 142 is provided in the installation cavity 14 to limit the camera lens 2, such that the second magnetic device 2111 is directly opposite to the first magnetic device 3. In this way, the first magnetic device 3 can attract the second magnetic device 2111, thereby calibrating each camera lens 2.

The above-described embodiments are merely exemplary embodiments of the present disclosure and are not intended to limit the present disclosure. Any modifications, equivalent substitutions and improvements made within the principle of the present disclosure shall fall into the protection scope of the present disclosure.

What is claimed is:

1. A zoom lens group, comprising:
a cover comprising an installation cavity;
a first magnetic device connected to the cover; and
at least two camera lenses, each of which is movably arranged in the installation cavity and provided with a second magnetic device,
wherein the first magnetic device is configured to attract the second magnetic device to calibrate each of the at least two camera lenses, in such a manner that axes of the at least two camera lenses coincide with each other.

2. The zoom lens group as described in claim 1, wherein the first magnetic device is arranged along a direction in which the installation cavity extends.

3. The zoom lens group as described in claim 1, wherein the cover is provided with an installation groove, and the first magnetic device is at least partially embedded in the installation groove.

4. The zoom lens group as described in claim 1, wherein the cover comprises a first cover wall and a second cover wall, wherein a transition portion is provided between the first cover wall and the second cover wall, and the first magnetic device is provided at the transition portion.

5. The zoom lens group as described in claim 4, wherein the first cover wall is perpendicularly connected to the second cover wall, and each of a normal of the first magnetic device and a normal of the second magnetic device forms an angle of 45° with the first cover wall.

6. The zoom lens group as described in claim 1, wherein each of the at least two camera lenses comprises a lens barrel and a lens connected to the lens barrel, wherein the lens barrel comprises a main body and the second magnetic device connected to the main body.

7. The zoom lens group as described in claim 6, wherein the main body comprises an installation base, and the second magnetic device is connected to the installation base.

8. The zoom lens group as described in claim 7, wherein the installation base comprises a groove, and the second magnetic device is embedded in the groove.

9. The zoom lens group as described in claim 1, wherein a gap is formed between the first magnetic device and the second magnetic device.

10. The zoom lens group as described in claim 1, wherein the first magnetic device is an iron bar, and the second magnetic device is a magnet.
